(19) United States
(12) Patent Application Publication
(10) Pub. No.: US 2014/0244033 A1
(43) Pub. Date: Aug. 28, 2014

(54) Automated Multi-Medication Dispenser

(71) Applicants: Semahat Serra Ucer, Little Rock, AR (US); Charles Mercado, North Hollywood, CA (US)

(72) Inventors: Semahat Serra Ucer, Little Rock, AR (US); Charles Mercado, North Hollywood, CA (US)

(21) Appl. No.: 14/184,940

(22) Filed: Feb. 20, 2014

Related U.S. Application Data
(60) Provisional application No. 61/768,695, filed on Feb. 25, 2013.

(51) Int. Cl. A61J 7/04

(52) U.S. Cl. CPC A61J 7/0481
USPC 700/237

(57) ABSTRACT

An automated medication dispenser which includes a storage container having a plurality of storage columns configured to store a plurality of pills, an input slot, an output slot, automated means for delivering pills from the input slot to the storage columns, and automated means for delivering pills from the storage columns to the output slot on a time-based or meal-based dosing schedule.

### CROSS-REFERENCE TO RELATED APPLICATIONS

This application claims the benefit of U.S. Provisional Application No. 61/768,695, entitled “Automated Multi-Medication Dispenser” and filed on Feb. 25 2013. The complete disclosure of said provisional patent application is hereby incorporated by reference.

### STATEMENT REGARDING FEDERALLY SPONSORED RESEARCH OR DEVELOPMENT

Not applicable

### BACKGROUND OF THE INVENTION

1. Field of the Invention

The present invention relates to a medication dispenser and more particularly to an automated multi-medication dispenser.

2. Brief Description of the Related Art

An on-going obstacle to the efficient and effective administration of medical care is patient non-compliance with medication dosing schedules. Non-compliance by patients, whether it be taking excessive medication or skipping doses, can lead to worsening medical conditions and thus increase medical costs. Patients commonly rely on memory or reminders from others to take the appropriate dose of medication at the appropriate time, however, these methods have proven to be ineffective.

It would therefore be desirable to develop a medication dispenser that is automated and capable of being programmed to dispense multiple medications on different dosing schedules.

### BRIEF SUMMARY OF THE INVENTION

The present invention is directed to an automated medication dispenser comprising a storage container configured to store a plurality of pills, an input slot, an output slot, automated means for delivering pills from the input slot to the storage container, and automated means for delivering pills from the storage container to the output slot on a time-based or meal-based dosing schedule.

These and other features, objects and advantages of the present invention will become better understood from a consideration of the following detailed description of the preferred embodiments in conjunction with the drawings as described following:

### BRIEF DESCRIPTION OF THE DRAWINGS

FIG. 1 is a perspective view of the medication dispenser of the present invention.

FIG. 2 is a cutaway view of the medication dispenser of the present invention.

FIG. 3 is a cutaway view of a storage column of the medication dispenser of the present invention.

FIG. 4 is a cutaway view of a storage column of the medication dispenser of the prevent invention.

FIG. 5 is a cutaway view of a storage column of the medication dispenser of the present invention.

### DETAILED DESCRIPTION OF THE INVENTION

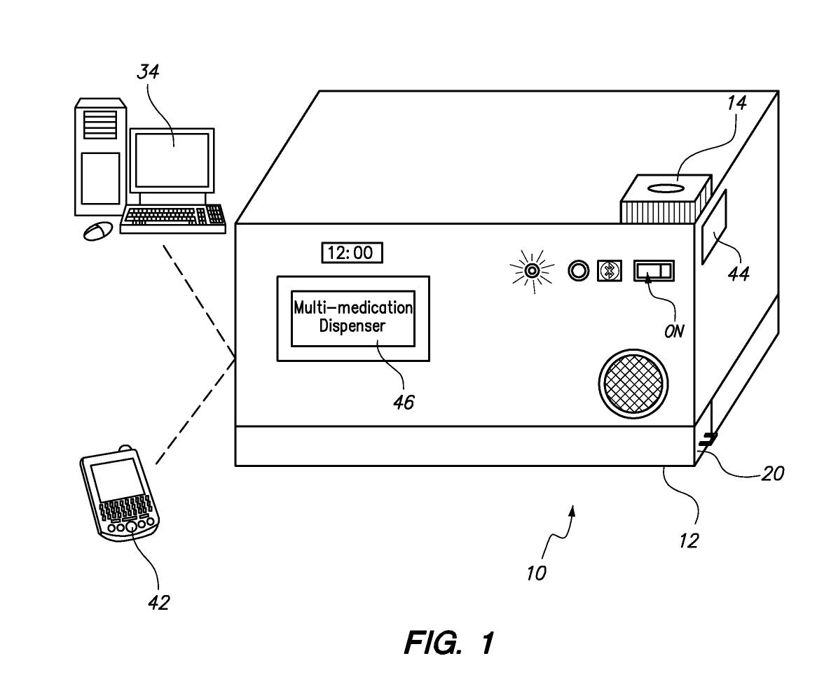

With reference to FIGS. 1-5, the preferred embodiments of the present invention may be described. The medication dispenser 10 is comprised of a storage container 12 which is preferably made of aluminum or other similar light-weight and durable materials. The storage container 12 is preferably square or rectangular in shape. While the medication dispenser 10 may be of various sizes, in one embodiment, the dispenser 10 is six inches in height, twelve inches in length, and four inches in width.

The exterior or outside surface of the storage container 12 includes an input slot 14 for loading the medications or pills 16. Medications of various sizes and shapes may be stored in the storage container 12. As shown in FIG. 1, in one embodiment, the input slot 14 is located on the top of the storage container 12 and is preferably raised from the top surface of the storage container 12 for easier inputting of the pills 16. Inside the storage container 12 are multiple storage columns 18 for holding the pills 16. The storage columns 18 are preferably stored in the storage container 12 in a matrix pattern which is defined as a rectangular or square pattern comprising multiple columns and rows. A storage column 18 preferably holds only one type of medication. Each storage column 18 preferably is nonremovable and sized to hold at least one month's supply of pills 16. The size of the storage container 12 will vary based on the number of storage columns 18 inside the container 12. In the preferred embodiments, the storage container 12 may include five, ten, or twenty storage columns 18. The exterior surface of the storage container 12 also includes an output slot 20 for receiving the dispensed pills 16. In one embodiment, the input slot 14 and output slot 20 are drawers. The drawer of the input slot 14 may be opened to insert the pills 16 to be stored inside the storage container 12, while the drawer of the output slot 20 may be opened to receive the pills 16 that have been dispensed. The drawers may be closed to deliver the pills 16 to the inside of the storage container 12 or closed when the drawer is not in use.

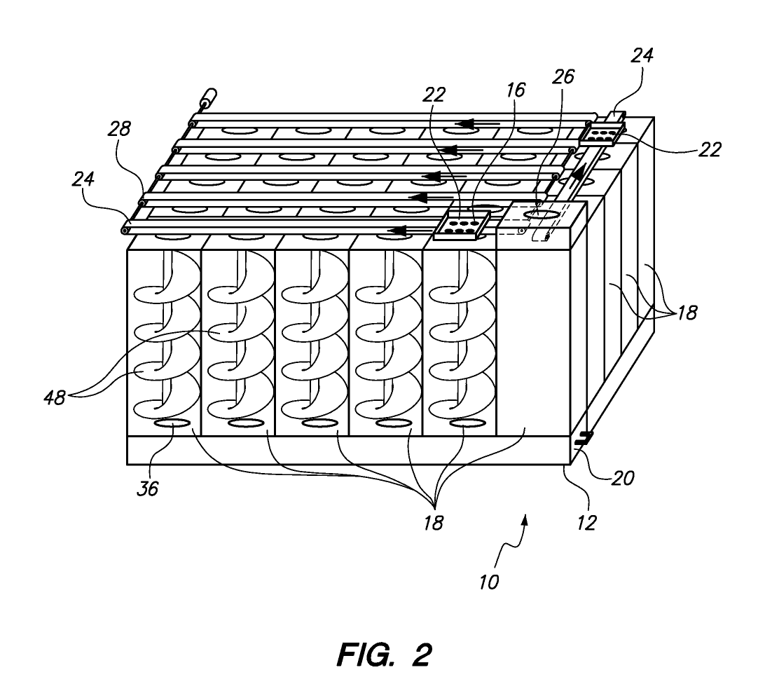

Once the pills 16 are poured or placed into input slot 14, the pills 16 are received in a cart 22 that moves on a conveyor 24 that extends across the top of the storage columns 18 as shown in FIG. 2. The pills 16 are loaded in the cart at the loading point 26 along the conveyor. The conveyer 24 and the cart 22 are connected to and powered by an electric system 28, which preferably includes a motor (e.g. servo-motor), and is of a type well-known to those skilled in the art. The cart 22 delivers the pills to the assigned column 18 to be stored. The cart improves the efficiency of loading the pills into the column 18 by ensuring that each drug is loaded properly. The cart 22 is programmed to load the columns 18 which are arranged in a matrix pattern. For example, the cart 22 receives the pills 16 at the loading point 26, the conveyor 24 moves the cart 22 to the appropriate column 18, the pills 16 are released from an opening in the bottom of the cart 22 into the column 18, and the cart 22 returns to the loading point 26 to receive the next load of pills 16 to deliver. The cart 22 is also attached to a vibrator 30 that causes the pills 16 to be oriented single-file. In other words, the vibration prevents the pills 16 from stacking on one another and ensures an orderly release of the pills 16 from the cart 22 to the column 18. The vibrator 30 is preferably of a type well-known to those skilled in the art.

A counter 32 is positioned at the bottom of the cart 22 to count the number of pills 16 that are released from the cart 22 and delivered to each storage column 18. The counter 32 is preferably of the type well-known to those skilled in the art. The counter 32 is in communication with a computer system 34, which provides a signal when the column 18 is full. Once the column 18 is full, the cart 22 on the conveyor 24 moves back to the loading point to receive a new load of pills 16 and then moves to the next column 18 for filling. This process for repeated for each column 18.

Each storage column 18 is comprised of two gates 36: one at the top of the column 18 where the pills 16 are loaded and one at the bottom of column 18 where the pills 16 are dispensed. Because each storage column 18 preferably only stores one type of medication, the gate 36 at the top of the storage column 18 prevents the unintended or accidental entry of other medications into that particular storage column 18. The top gates 36 preferably have an auto-lock feature after the appropriate medications are delivered into the storage column 18, which provides a feedback mechanism. That is, the closure of the top gate 36 after the column 18 is full signals the cart 22 to return to the loading point 26 for reloading.

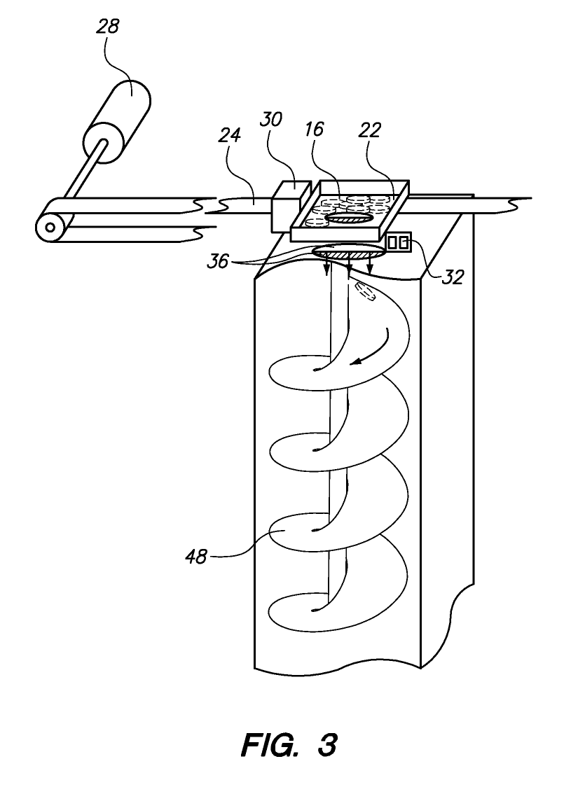

As shown in FIGS. 3-5, each storage column 18 is preferably comprised of a helicoid 48. The helicoid 48 has a top-to-bottom rotation which moves the pills 16 in the storage column 18 from the top of the column to the bottom of the column for dispensing. The rotation of the helicoid 48 allows smooth movement of the pills 16 within the column 18 and prevents them from stacking on one another. In one embodiment, one pill 16 is dispensed per turn of the helicoid 48. The helicoid 48 is preferably powered by an electrical system 28, which preferably includes a motor (e.g. servo-motor) and a solenoid valve. The electrical system 28 preferably is of a type well-known to those skilled in the art. The helicoid 48 is in communication with a computer system 34 for the automated dispensing of the pills 16.

The gate 36 at the bottom of the storage column 18 is preferably a shutter. The shutter is capable of opening in incremental amounts to control the number of pills dispensed to the output slot or drawer 20. Thus, the shutter will open wider if the pill size is larger or if multiple pills are being dispensed. The gate 36 at the bottom of the column 18 is also equipped with a counter 32 of the same type as the counter 32 on the cart 22. The counter 32 serves as a checkpoint that the number of pills 16 dispensed is accurate. Based on the remaining weight in the column 18, the counter is capable of determining the number of pills 16 remaining in column 18. The dispenser 10 can be set to sound an alarm when the number of pills 16 in a particular column 18 is below a certain number.

Dispensing the pills 16 from the storage column 18 may also be controlled via an air pressure system. The air pressure system preferably includes a manifold with a solenoid valve and is of a type well-known to those skilled in the art. The air pressure system is utilized to measure and regulate the air pressure inside each storage column 18. The pressure in the storage column 18 will change after dispensing one or more pills 16 based on the size and weight of the dispensed pills 16. In this system, the shutter is automatically closed once the air pressure in the storage column 18 has changed accordingly.

In an alternative embodiment, a laser technology system may be utilized to aid in the sorting and dispensing of pills 16 in each storage column 18. A sensor (e.g. LED sensor or photo-interrupter) is capable of counting the number of pills 16 that are dispensed and then close the shutter when appropriate via a feedback loop.

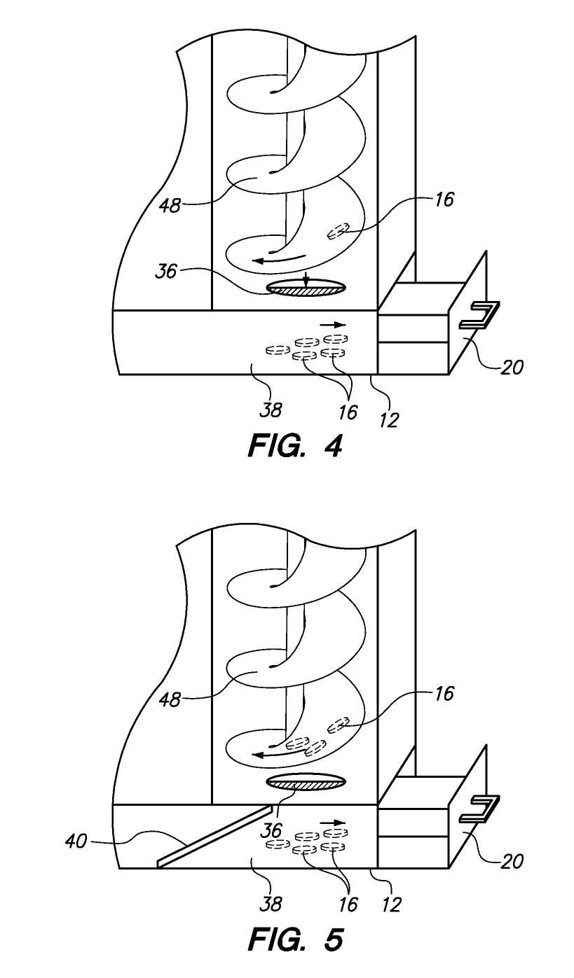

As shown in FIGS. 4-5, the pills 16 are released from the storage column 18 into a bottom tray 38. A sweeper 40 moves across the top surface of the bottom tray 38 and moves the released pills 16 into the outlet slot or drawer 20 where they can be removed by the patient or their caregiver.

Operation of the medication dispenser 10 is completely automated through use of a computer system 34 that is in communication with the medication dispenser 10. Through the use of software on the computer 34, the dispenser 10 can be programmed to dispense medications either on a time-dosing schedule or a meal-based dosing schedule. A dosing schedule is entered for each medication stored in the medication dispenser 10 and the dispenser is capable of dispensing multiple drugs on different dosing schedules. By providing a secure medication storage device that controls the dispensing of prescription drugs, the dispenser 10 serves as a valuable tool in preventing the abuse of pharmaceuticals, including pain killers.

A PIN code is required to manipulate the system, including loading medications, setting or changing the dosing and dispensing schedule, and/or manually dispensing the medications. In an alternative embodiment, as an added security measure, a fingerprint detector is utilized. The dispenser also includes a chip that allows the dispenser to be monitored and programmed remotely via a personal computer and a mobile application on a mobile device 42 (e.g. cellphone).

The medication dispenser 10 also includes an alarm reminder system to help in ensuring patient compliance to medication schedules. In addition to an audible alarm that is activated at the medication dispenser itself, the alarm system is capable of utilizing wireless or Bluetooth networks to send reminder phone calls, e-mails, and/or text messages to authorized mobile devices. As shown in FIG. 1, the exterior of the dispenser 10 may include a Bluetooth indicator and an alarm light that flashes when the alarm is activated. Because the dispenser 10 is in communication with a mobile device 42 through GPS technology or other means well-known to those skilled in the art, the dispenser includes a “find your cellphone” button to assist in locating the mobile device 42.

The medication dispenser 10 also includes a bar-code reader 44. When the barcode on the medication bottle is read before loading the drugs into the dispenser 10, the medication dispenser 10 is able to retrieve and store medication information, including the name or brand of the drug, the dose per tablet, side effects of the drug, expiration dates, precautions and special instructions for administering the drug, the weight of a single pill of the drug, and the shape of the drug. As described above, the weight of the pills is important in regulating the number of pills that are dispensed. This information is then accessible to the patient or the patient's caregiver through an LCD screen 46 on the outside surface of the dispenser 10 or through the mobile application. The LCD screen 46 preferably is capable of being tilted side-to-side or back-to-front for ease of viewing.

By storing the medication information of the drugs loaded into the dispenser 10, the patient and the patient's caregiver and doctor(s) can track through the mobile application the medications being prescribed for the patient and identify possible side effects. The doctor(s) will also have access to other drug information, including drug formulations, warnings, and pharmacodynamics and pharmacokinetic information.

Over-the-counter (OTC) medications can also be programmed to be dispensed by the medication dispenser 10. While the prescription medications only dispense at certain times, OTC medications can be manually retrieved by the patient as needed. The medication dispenser 10, however, will not dispense more pills than allowed in a certain time period according to the label of the OTC medication.

In one embodiment, the medication dispenser 10 is small and portable, which allows it to be taken to the pharmacy for refills to be made directly into the medication dispenser 10 utilizing the bar-code process described above. In another embodiment, a larger dispenser 10 may be used bedside at medical facilities, including hospitals, to allow health care providers to more efficiently and timely provide medications to patients.

The present invention has been described with reference to certain preferred and alternative embodiments that are intended to be exemplary only and not limiting to the full scope of the present invention.

We claim:

1. An automated medication dispenser, comprising:
(a) a storage container holding a plurality of pills, wherein said storage container comprises a plurality of storage columns arranged in a matrix pattern, wherein each of said plurality of storage columns comprises a top portion and a bottom portion;
(b) an input slot for loading said plurality of pills into said storage container;
(c) an output slot for dispensing said plurality of pills from said storage container, wherein said plurality of pills are dispensed from said storage container on a pre-programmed dosing schedule;
(d) a conveyor, wherein said conveyor is connected to said top portions of said plurality of storage columns;
(e) a cart, wherein said cart travels on said conveyor and transports said plurality of pills within said storage container.

2. The automated medication dispenser of claim 1, wherein said cart comprises an outlet for releasing said pills into said plurality of storage columns.

3. The automated medication dispenser of claim 1, wherein said conveyor and said cart are powered by an electrical system.

4. The automated medication dispenser of claim 1, wherein said cart further comprises a vibrator.

5. The automated medication dispenser of claim 1, wherein said pre-programmed dosing scheduled is either a time-based dosing schedule or a meal-based dosing schedule.

6. The automated medication dispenser of claim 1, wherein said cart further comprises a counter.

7. The automated medication dispenser of claim 1, wherein said medication dispenser is in communication with a computer system.

8. The automated medication dispenser of claim 1, wherein each of said plurality of storage columns comprises a top gate and a bottom gate.

9. The automated medication dispenser of claim 1, wherein each of said plurality of storage columns comprises a helicoid, wherein said helicoid rotates to move said plurality of pills from said top portions of said plurality of said storage columns to said bottom portions of said plurality of storage columns.

10. The automated medication dispenser of claim 1, wherein each of said bottom portions of said plurality of storage columns comprises a counter.

11. The automated medication dispenser of claim 8, wherein said bottom gate is controlled by an air pressure system.

12. The automated medication dispenser of claim 1, further comprising a laser system for controlling a dispensing of said plurality of pills from said plurality of storage columns.

13. The automated medication dispenser of claim 1, further comprising a bottom tray, wherein said bottom tray is positioned below said bottom portions of said plurality of storage columns, wherein said bottom tray receives said plurality of pills from said plurality of storage columns.

14. The automated medication dispenser of claim 13, further comprising a sweeper, wherein said sweeper moves said plurality of pills from said bottom tray to said outlet slot.
